(19) United States
(12) Patent Application Publication
(10) Pub. No.: US 2008/0141015 A1
(43) Pub. Date: Jun. 12, 2008

(54) SYSTEM AND METHOD FOR OPERATING SYSTEM DEPLOYMENT IN A PEER-TO-PEER COMPUTING ENVIRONMENT

(76) Inventors: Glen Edmond Chalemin, Austin, TX (US); Indran Naick, Cedar Park, TX (US); Clifford Jay Spinac, Austin, TX (US); Calvin Lui Sze, Austin, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(21) Appl. No.: 11/567,599

(22) Filed: Dec. 6, 2006

(51) Int. Cl. G06F 9/445; G06F 15/177

(52) U.S. Cl. 713/2; 717/177

(57) ABSTRACT

A system, method, and program product is provided that deploys an operating system. The first computer system sends a Wake-on-LAN instruction and boots each of the second computer systems. The second computer system identifies a set of third computer identifiers that corresponds to each of the selected second computer systems. The second computer systems send the Wake-on-LAN instruction to each of the third computer systems, and the third computer systems are booted over the computer network from the second computer systems. A control file lists the first computer system as a “server” of the second computer systems and lists the second computer systems as “servers” of the third computer systems. The control file is transmitted from a server to each of the server's clients. When a client is booted, it checks the control file to determine if the client is also a server to other computer systems.

### BACKGROUND OF THE INVENTION

1. Technical Field

The present invention relates to a system and method that deploys an operating system in a peer-to-peer network environment. More particularly, the present invention relates to a system and method that uses a hierarchy of client/servers that deploy the operating system to other clients in the peer-to-peer network.

2. Description of the Related Art

A peer-to-peer computer network is a network that relies primarily on the computing power and bandwidth of the participants in the network rather than concentrating it in a relatively low number of servers. Peer-to-peer networks are typically used for connecting nodes via largely ad hoc connections. Peer-to-peer networks are used for many purposes, such as sharing files containing audio, video, data or anything in digital format. In addition, peer-to-peer networks are used to pass real-time data, such as telephony traffic.

One advantage of peer-to-peer networks is that all clients provide resources, including bandwidth, storage space, and computing power. Thus, as nodes arrive and demand on the system increases, the total capacity of the system also increases. This is not true of a client-server architecture with a fixed set of servers, in which adding more clients could mean slower data transfer for all users. The distributed nature of peer-to-peer networks also increases robustness in case of failures by replicating data over multiple peers.

One type of peer-to-peer network are computers arranged in a “grid” environment. A grid environment is an emerging computing model that provides the ability to perform higher throughput computing by taking advantage of many networked computers to model a virtual computer architecture that is able to distribute process execution across a parallel infrastructure. Grids use the resources of many separate computers connected by a network, such as the Internet, to solve large-scale computations. Grids provide the ability to perform computations on large data sets, by breaking them down into many smaller ones, or provide the ability to perform many more computations at once than would be possible on a single computer, by modeling a parallel division of labor between processes.

A challenge in managing large peer-to-peer networks, such as those arranged in a grid environment, is deploying, and updating, the operating systems used by the individual computer systems that make up the peer-to-peer network. One approach is to manually install the operating systems onto the various computer systems. Because many computer systems can be involved, a manual operation of this sort is typically takes considerable time. Another approach is to clone one system's hard drive onto a number of other hard drives and then physically install the cloned drives into the other computer systems. A challenge with this approach is, again, the time needed to clone the hard drives and the need to physically install the cloned drives into the various systems (i.e., requiring physical access to the various computer systems included in the peer-to-peer network).

### SUMMARY

It has been discovered that the aforementioned challenges are resolved using a system, method and computer program product that identifies, at a first computer system, one or more second computer system identifiers that correspond to a plurality of second computer systems. The first computer system sends, via the computer network, a Wake-on-LAN instruction to each of the second computer systems. The first computer system also boots the second computer systems over the computer network. When the second computer systems are booted, they identify a set of third computer identifiers that corresponds to each of the selected second computer systems. Each of the second computer systems sends, via the computer network, the Wake-on-LAN instruction to each of the third computer systems, and the third computer systems are booted over the computer network from the second computer systems. In one embodiment, a control file lists the first computer system as a “server” of the second computer systems and lists the second computer systems as “servers” of the third computer systems. The control file is transmitted from a server to each of the server's clients. When a client is booted, it checks the control file to determine if the client is also a server to one or more other computer systems.

In one embodiment, the server computer systems listen for boot requests being transmitted by requesters. The servers compare the requesters' identifiers to identifiers in the control file that indicate which clients are being handled by the particular server. If a requestor is one of the clients being managed by the server, then the server responds to the boot request by booting the requestor.

In one embodiment, in addition to booting the client computer systems, the servers also transfer an operating system image to each of the booted second computer systems, with the operating system image corresponding to an operating system. The operating system is then installed on the client computer systems using the transferred operating system images.

In another embodiment, before sending the Wake-on-LAN instructions to the client computer systems, the computer systems are prepared, or “readied.” A ready instruction is received at the computer systems. This causes each computer system to read a control file that determines whether the computer system is a server computer system to other computer systems. If the computer system is a server computer system, then the server computer system sends the ready instruction to its client computer systems. The ready instruction causes the system to set a Wake-on-LAN flag in the computer system, set a boot from LAN flag, and shutdown the computer system. Now, the computer system is prepared to receive a Wake-on-LAN instruction and boot from the network.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a system diagram showing components used to deploy an operating system to multiple computer systems in a peer-to-peer network;

FIG. 2 is a depiction of a sample control file used to control deployment of the operating system to the computer systems in the network;

FIG. 3 is a depiction of a sample hierarchy of computer systems included in the peer-to-peer network where the operating system is deployed;

FIG. 4 is a flowchart showing the steps taken when a computer system boots in order to deploy the operating system;

FIG. 5 is a flowchart showing the steps performed when a computer system is performing the server routine;

FIG. 6 is a flowchart showing the steps taken in handling requests, including resetting the computer systems in order to ready the systems for installation of an updated operating system; and

FIG. 7 is a block diagram of a data processing system in which the methods described herein can be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

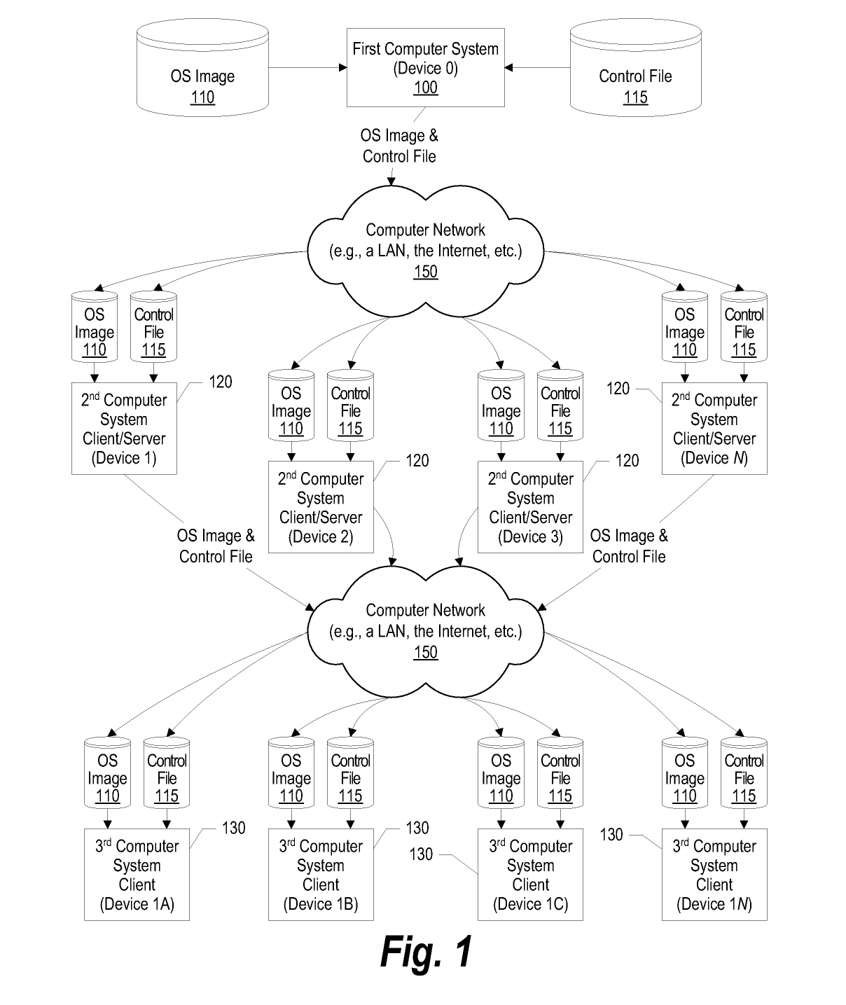

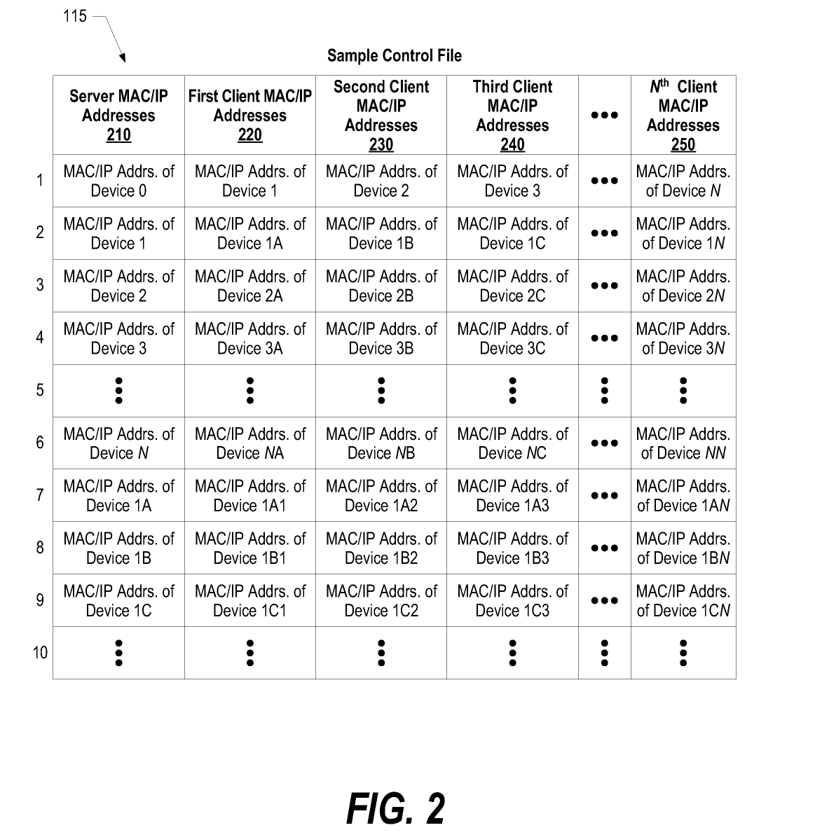

FIG. 1 is a system diagram showing components used to deploy an operating system to multiple computer systems in a peer-to-peer network. First computer system 100 (Device 0) acts as a server for second computer systems 120 (Devices 1, 2, 3, through N). In one embodiment, first computer system 100 identifies second computer systems 120 by reading control file 115. Control file 115 identifies the various computer systems that act as servers as well as the clients that are served by the various servers. An example of control file 115 is shown in FIG. 2. In one embodiment, first computer system 100 transfers operating system image 110 to its clients (second computer systems 120) in order to install the operating system onto the second computer systems. First computer system 100 sends a Wake-on-LAN instruction to second computer systems 120 through computer network 150. When second computer systems 120 wakeup (in response to receiving the Wake-on-LAN instruction), they broadcast a boot request over computer network 150. First computer system 100 listens for the boot requests and, when the requests are detected, first computer system 100 boots the various second computer systems 120. After the second computer systems are booted, they receive control file 115 from first computer system 100 via computer network 150. In addition, in one embodiment, operating system image 110 is transmitted from first computer system 100 through computer network 150 to second computer systems 120. The operating system images are then used to install the operating system on the various second computer systems so that, in the future, the second computer systems can be booted without having to boot the systems from the network.

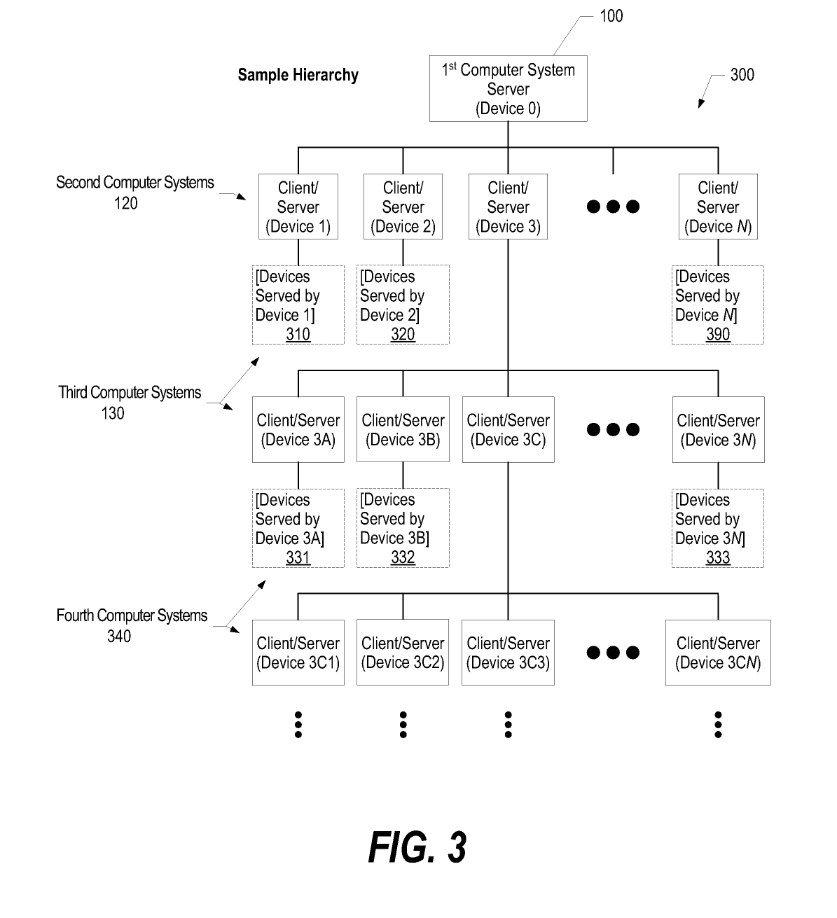

Second computer systems 120, as shown, identify third computer systems 130 using control file 115. The second computer systems are identified as clients of first computer system 100 and as servers of the various third computer systems 130. The second computer systems act in a manner analogous to the first computer system described above. Second computer systems 120 identify their respective clients (third computer systems 130) by reading control file 115. In the example shown, the second computer system identified as “Device 1” acts as a server for third computer systems 130 (Devices 1A, 1B, 1C, through 1N). Likewise, the second computer system identified as “Device 2” would act as a server for third computer systems 130 (Devices 2A, 2B, 2C, through 2N which are not shown in FIG. 1 but appear in FIGS. 2 and 3). “Device 3” would act as a server for third computer systems 130 (Devices 3A, 3B, 3C, through 3N which are not shown in FIG. 1 but appear in FIGS. 2 and 3). This would continue through to “Device N” which acts as a server for third computer systems 130 (Devices NA, NB, NC, through NN). In the example shown, third computer systems 130 are shown as being the end nodes (i.e., not having their own clients), however, if control file 115 lists third computer systems 130 as having clients, they would perform Wake-on-LAN requests to fourth computer systems, boot the fourth computer systems, and transfer operating system image 110 and control file 115 to the individual computer systems (devices) that are included in the fourth computer systems.

Using the methodology described above, any number of computer system levels (e.g., fifth computer systems, sixth computer systems, etc.) can be employed. In this manner, the number of clients serviced by each server can be optimized based on the operating environment. Suppose, for example, that an optimal number of clients to be serviced by an individual server is ten. If the grid or peer-to-peer network has roughly one hundred computer systems, then three levels of computer systems would be used (first computer system 100, second computer systems 120, and third computer systems 130) with the third computer systems being the end nodes. On the other hand, if the grid or peer-to-peer network has one thousand computer systems, then four levels of computer systems would be used (first computer system 100, second computer systems 120, third computer systems 130, and fourth computer systems 340 (seen in FIG. 3) that would be clients of third computer systems 130.

FIG. 2 is a depiction of a sample control file used to control deployment of the operating system to the computer systems in the network. Control file 115 identifies the various servers and the clients served by the servers. As can be seen, computer systems can be both a client and a server. Control file 115 has a number of fields. Field 210 identifies the unique identifier(s) of the computer systems that are used as servers. Examples of unique identifiers include a MAC address and an IP address.

Along with server identifier field 210 are several client identifier fields 220, 230, 240, through 250. Note that the devices that appear in the control file shown in FIG. 2 correspond to devices (e.g., computer systems) shown in both FIGS. 1 and 3. For example, the first line of the control file in FIG. 2 identifies Device 0 as the first computer system which is the server for Devices 1 through Device N. The second line of the control file shown in FIG. 2 identifies Device 1 as one of the second computer systems that acts as a server for Devices 1A through Device 1N. Likewise, the third and fourth lines of the control file identify Devices 2 and 3, respectively, as servers for client Devices 2A through Device 2N and client Devices 3A through Device 3N, respectively. Following the first row of ellipses, the last of the second computer systems (Device N) is shown as a server for client Devices NA through Device NN.

The next row (row 7) shows a fourth set of computer systems being served by computer systems included in the third computer systems. Device 1A (a third computer system) is shown serving Devices 1A1 through 1AN. Row 8 shows Device 1B serving Devices 1B1 though 1BN, and row 9 shows Device 1C serving Devices 1C1 though 1CN. The ellipses in row 10 indicate that the definition of servers and clients continues until all servers and clients are identified.

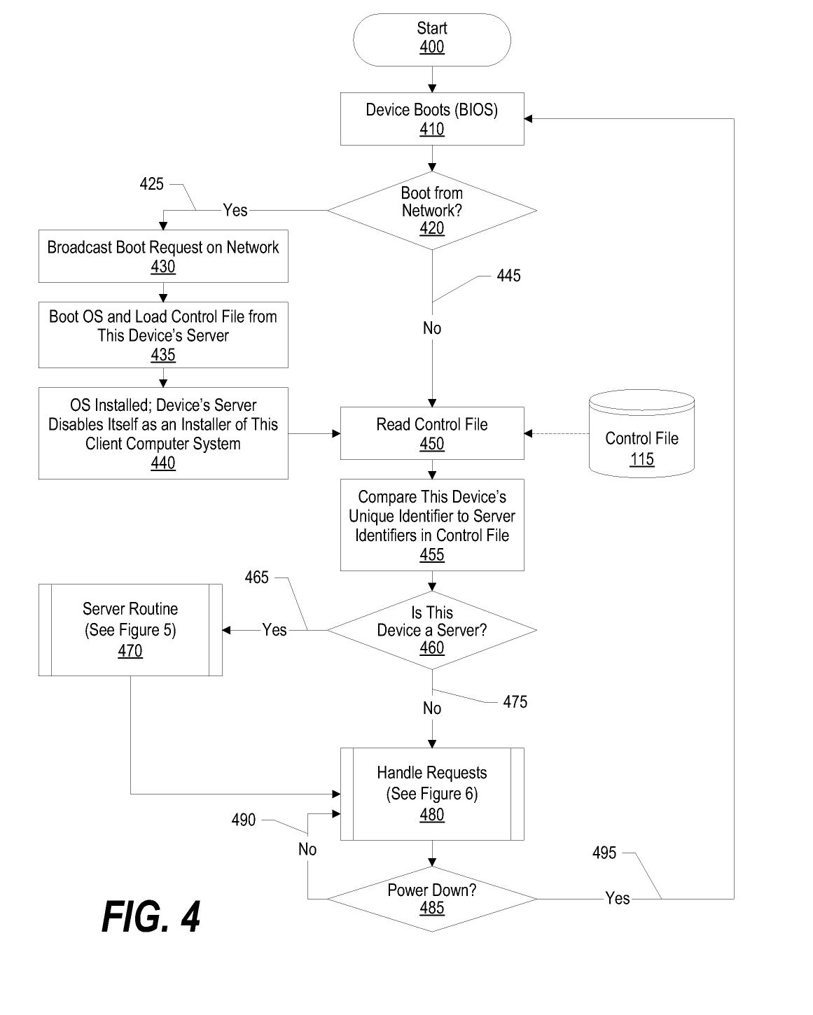

As will be further explained in FIGS. 4-6, when a client is initialized, it is booted and a copy of control file 115 is loaded on the client computer system. The client then runs a routine that checks control file 115 to see if the computer system is also a server computer system. For example, when Device 1 initializes, it would read control file 115 and see that it (Device 1) is also listed as being a server by comparing its unique identifier to the unique identifier stored in server field 210. In this example, Device 1 would read row 2 from control file 115 and proceed to wakeup and boot the client computer systems identified in row 2.

FIG. 3 is a depiction of a sample hierarchy of computer systems included in the peer-to-peer network where the operating system is deployed. Hierarchy 300 includes first computer system 100, second computer systems 120, third computer systems 130 and fourth computer systems 340. The relationship of servers and their clients is detailed in the sample control file shown in FIG. 2. First computer system 100 servers clients referred to as second computer systems 120 (Devices 1, 2, 3, through Device N). Third computer systems 130 include devices served by second computer systems 120 (Devices 310 served by Device 1, Devices 320 served by Device 2, Devices 390 served by Device N, and Device 3A, 3B, 3C through 3N served by Device 3). Fourth computer systems 340 include devices served by third computer systems 130 (including Devices 331, Devices 332, Device 3C1, Device 3C2, Device 3C3, though Device 3CN and Devices 333).

FIG. 4 is a flowchart showing the steps taken when a computer system boots in order to deploy the operating system. Processing commences at 400 whereupon, at step 410 the computer system boots (e.g., by processing boot instructions stored in the system's BIOS). A determination is made as to whether the computer system is booting from the network (decision 420). In one embodiment, this determination is made by reading a boot from network flag from a nonvolatile memory location (e.g., CMOS, etc.) during the BIOS boot routine.

If the computer system is booting from the network, then decision 420 branches to “yes” branch 425 whereupon, at step 430, the computer system broadcasts a boot request across the computer network. The computer system's server responds and boots the computer system at step 435. Also, during step 435, control file 115 is loaded onto the computer system from the server. At step 440, the operating system is installed by processing an operating system image received from the server. In addition, at step 440, the device's server disables itself as an installer of this client computer system. Returning to decision 420, if the device (computer system) is not booting from the network, then decision 420 branches to “no” branch 445 bypassing steps 430 through 440.

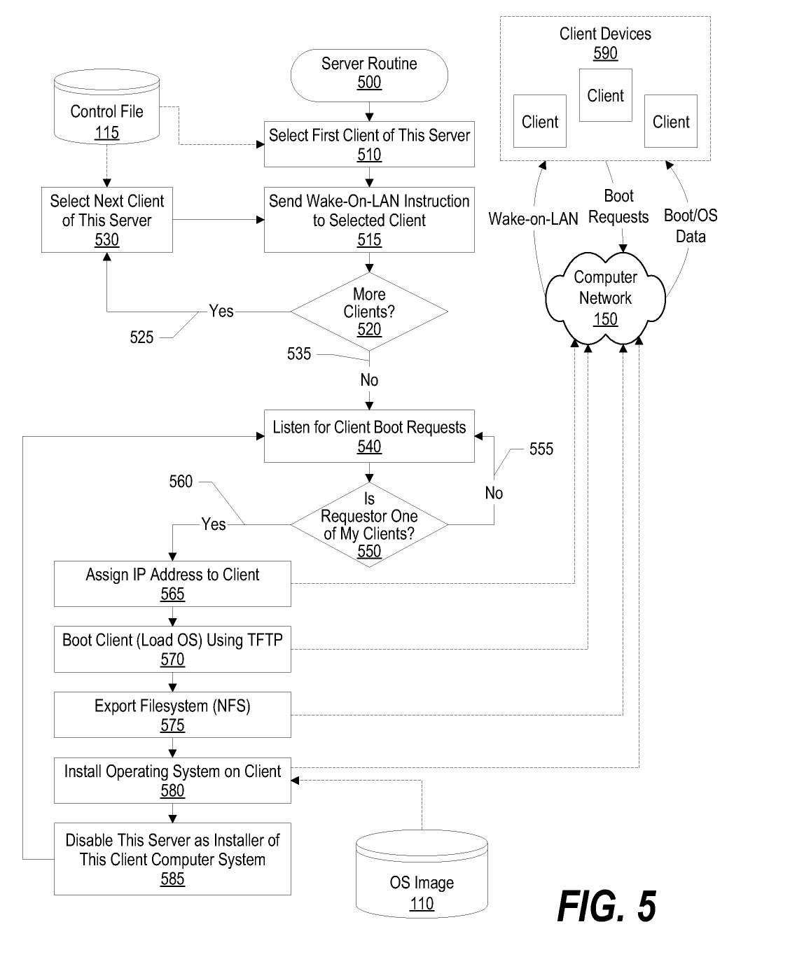

At step 450, the computer system reads control file 115 (see FIG. 2 for an example control file). At step 455, this device's unique identifier (e.g., MAC address, IP address, etc.) is compared to a set of server identifiers included in the control file. A determination is made, based on the comparison, as to whether this device is also a server for one or more other devices (decision 460). If this device is a server, then decision 460 branches to “yes” branch 465 whereupon, at predefined process 470, the device executes a server routine (see FIG. 5 and corresponding text for server processing details). On the other hand, if this device does not act as a server, then decision 460 branches to “no” branch 475 bypassing predefined process 470.

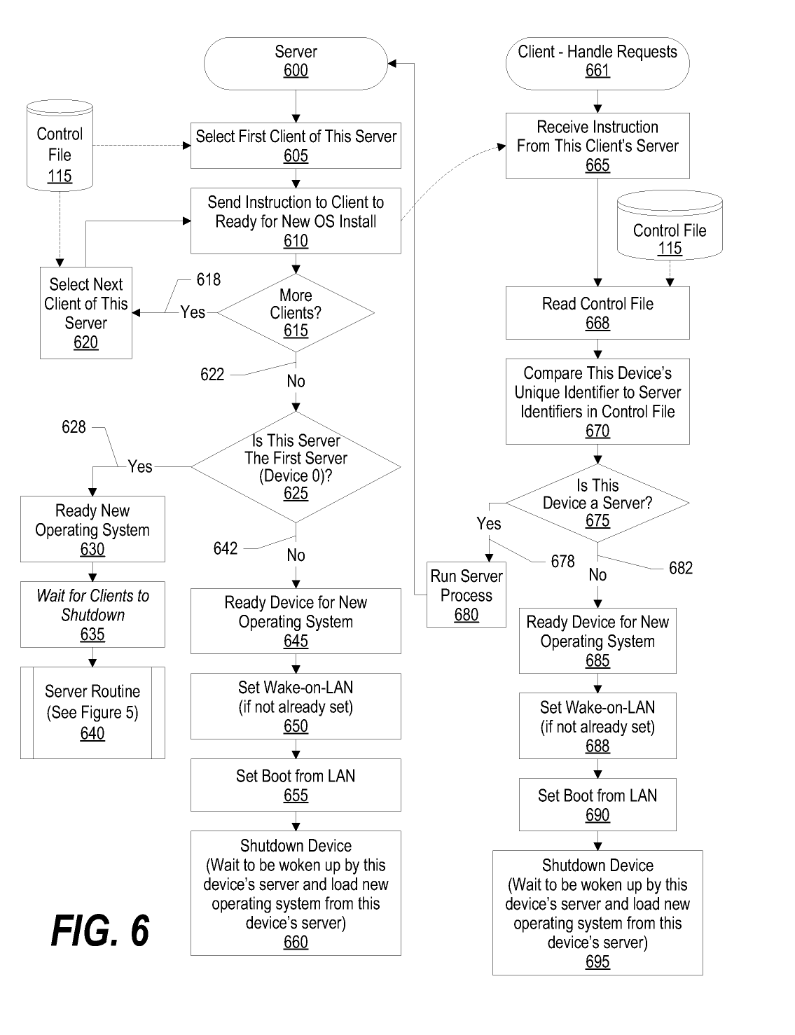

At predefined process 480, the device handles various requests (see FIG. 6 and corresponding text for processing details). As can be seen in FIG. 6, one of the requests that can be handled is to “ready” the device for another boot request. A determination is made as to whether, based on the requests received, to power down the device (decision 485). If the device is not powered down, decision 485 branches to “no” branch 490 and continues to handle requests. This continues until the device is powered down, at which point decision 485 branches to “yes” branch 495. After the device is powered down, at some point it is booted (e.g., with a Wake-on-LAN command received from the device's server), at which point the steps shown in FIG. 4 are repeated.

FIG. 5 is a flowchart showing the steps performed when a computer system is performing the server routine. Processing commences at 500 whereupon, at step 510, the server (e.g., first computer system 100) selects the first client of this server listed in control file 115 (see FIG. 2 for an example of a control file). At step 515, the server sends a Wake-on-LAN instruction to the selected client. A determination is made by reading control file 115 as to whether the server has more clients to process (decision 520). If the server has more clients, then decision 520 branches to “yes” branch 525 whereupon, at step 530, the next client for this server is selected and processing loops back to send the Wake-on-LAN instruction to the newly selected client. This looping continues until all clients for this server have been sent the Wake-on-LAN instruction, at which point decision 520 branches to “no” branch 535.

At step 540, the server listens for client boot requests. When the client computer systems were woken up using the Wake-on-LAN instruction, they powered on and booted using the BIOS stored in the client computer systems which instructed the client computer systems to boot from the network (LAN). As shown in FIG. 4, the client computer systems broadcast a boot request on the network (step 430). and, in FIG. 5, the servers listen for the boot requests. Control file 115 lists many servers that serve different client computer systems. Because many servers are operating at the same time, when a client boot request is received at step 540, the client's unique identifier is compared to the server's client identifiers and a determination is made as to whether the client that is making the boot request is one of this server's clients (decision 550). If the client making the boot request is not one of this server's clients, then decision 550 branches to “no” branch 555 which loops back to continue listening for client boot requests. On the other hand, if the client making the boot request is one of this server's clients, then decision 550 branches to “yes” branch 560. At step 565, the server assigns an IP address to the client computer system. At step 570, the server boots the client using TFTP. In one embodiment, such as in a Linux environment, a filesystem is exported to the client computer system at step 575. At step 580, the operating system is installed on the client computer system using operating system image 110. Finally, at step 585, the server is disabled as the installer of the client computer system. As shown, the assignment of the IP address, the boot requests, and the boot and/or operating system data are transmitted between the server computer system and client computer systems 590 via computer network 150.

In one embodiment, the client computer system clears the boot from network flag so that, when the client computer system is re-booted, the client computer system boots using the operating system installed on the client computer system rather than booting from the network. When a new operating system or a new version of the operating system is being deployed, the client computer system is readied for the deployment using the steps shown in FIG. 6.

FIG. 6 is a flowchart showing the steps taken in handling requests, including resetting the computer systems in order to ready the systems for installation of an updated operating system. When a new operating system (or a new version of an operating system) needs to be deployed, server processing is initiated at 600 (e.g., at first computer system 100). At step 605, the first server (e.g., first computer system 100) selects the first client for the server from control file 115. At step 610, the server sends the selected client an instruction to ready the client for a new operating system deployment. A determination is made, based on the data in control file 115, as to whether there are more clients of this server (decision 615). If there are more clients of this server, then decision 615 branches to “yes” branch 618 whereupon, at step 620, the next client of this server is selected from control file 115 and processing loops back to send the newly selected client the instruction to ready itself for a new operating system deployment. This looping continues until all clients of this server have been sent the instruction to ready for the new operating system deployment, at which point decision 615 branches to “no” branch 622.

A determination is made as to whether this server is the first server (e.g., first computer system 100, also referred to as Device 0) in the peer-to-peer network or grid (decision 626). If this is the first server, then decision 625 branches to “yes” branch 628 whereupon, at step 630, the first server (first computer system 100) is readied for the new operating system deployment (e.g., by automatically or manually installing the operating system on first computer system 100). At step 635, the first server waits for the clients in the peer-to-peer network to shutdown. Once the clients have been shutdown (i.e., with Wake-on-LAN enabled), the first server runs predefined process 640 which executes the server routine that deploys the operating system (see FIG. 5 and corresponding text for processing details).

Returning to decision 625, if this server is not the first server (e.g., this computer system is one of the second computer systems, etc.), then decision 625 branches to “no” branch 642 whereupon, at step 645, the computer system is readied for the new operating system. This includes setting the device's Wake-on-LAN flag (step 650) so that the device can be woken up by the device's server and, at step 655, setting the device's boot from network flag so that the device will boot from the network rather than booting from an operating system previously installed on the device. At step 660, the device is shutdown. At this point, the device waits to be woken up by the device's server as identified in control file 115.

Turning now to the client's handling of ready instructions, processing commences at 661 whereupon, at step 665, the client receives a ready instruction from the client's server. At step 668, the client reads control file 115 and, at step 670, the client compares its unique identifier (e.g., MAC address, IP address, etc.) to the server identifiers listed in control file 115. A determination is made as to whether this client device is also a server to other devices (decision 675). If this device is also a server to other devices, then decision 675 branches to “yes” branch 678 whereupon, at step 680, the server process is executed (steps 600 through 660). On the other hand, if this device does not act as a server to other devices, then decision 675 branches to “no” branch 682, whereupon, at step 685, the computer system is readied for the new operating system. This includes setting the device's Wake-on-LAN flag (step 688) so that the device can be woken up by the device's server and, at step 690, setting the device's boot from network flag so that the device will boot from the network rather than booting from an operating system previously installed on the device. At step 695, the device is shutdown. At this point, the device waits to be woken up by the device's server as identified in control file 115.

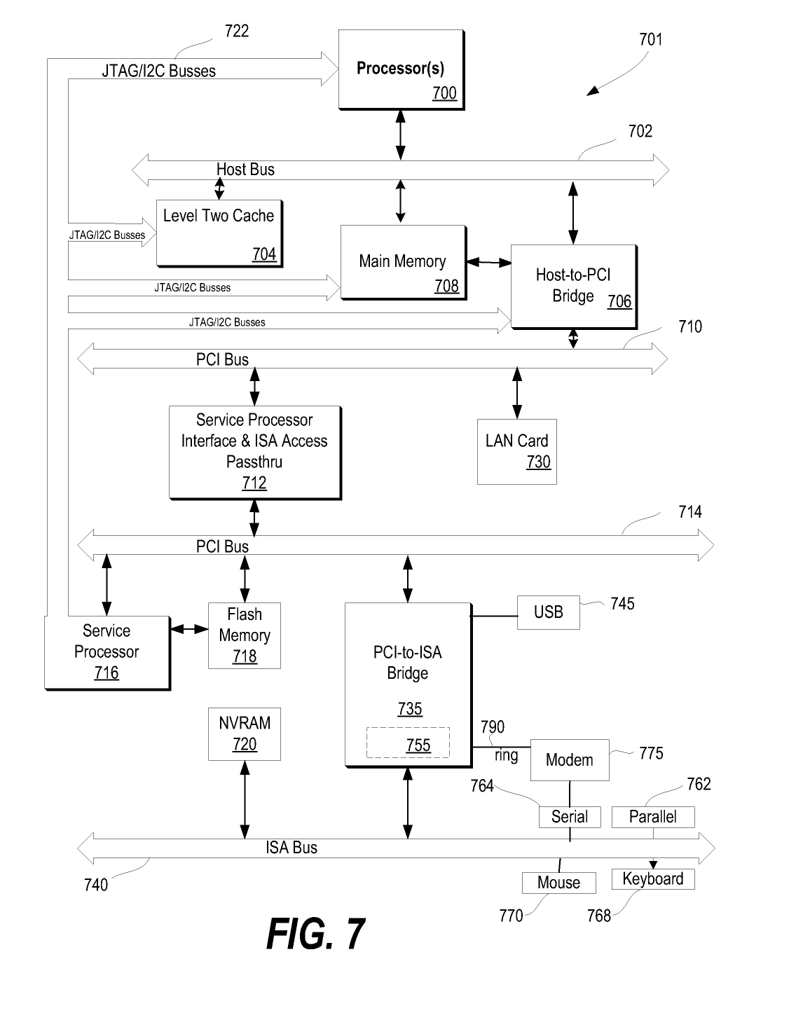

FIG. 7 illustrates information handling system 701 which is a simplified example of a computer system capable of performing the computing operations described herein. Computer system 701 includes processor 700 which is coupled to host bus 702. Time-day card 799 and a level two (L2) cache memory 704 is also coupled to host bus 702. Host-to-PCI bridge 706 is coupled to main memory 708, includes cache memory and main memory control functions, and provides bus control to handle transfers among PCI bus 710, processor 700, L2 cache 704, main memory 708, and host bus 702. Main memory 708 is coupled to Host-to-PCI bridge 706 as well as host bus 702. Devices used solely by host processor(s) 700, such as LAN card 730, are coupled to PCI bus 710. Service Processor Interface and ISA Access Pass-through 712 provides an interface between PCI bus 710 and PCI bus 714. In this manner, PCI bus 714 is insulated from PCI bus 710. Devices, such as flash memory 718, are coupled to PCI bus 714. In one implementation, flash memory 718 includes BIOS code that incorporates the necessary processor executable code for a variety of low-level system functions and system boot functions.

PCI bus 714 provides an interface for a variety of devices that are shared by host processor(s) 700 and Service Processor 716 including, for example, flash memory 718. PCI-to-ISA bridge 735 provides bus control to handle transfers between PCI bus 714 and ISA bus 740, universal serial bus (USB) functionality 745, power management functionality 755, and can include other functional elements not shown, such as a real-time clock (RTC), DMA control, interrupt support, and system management bus support. Nonvolatile RAM 720 is attached to ISA Bus 740. Service Processor 716 includes JTAG and I2C busses 722 for communication with processor(s) 700 during initialization steps. JTAG/I2C busses 722 are also coupled to L2 cache 704, Host-to-PCI bridge 706, and main memory 708 providing a communications path between the processor, the Service Processor, the L2 cache, the Host-to-PCI bridge, and the main memory. Service Processor 716 also has access to system power resources for powering down information handling device 701.

Peripheral devices and input/output (I/O) devices can be attached to various interfaces (e.g., parallel interface 762, serial interface 764, keyboard interface 768, and mouse interface 770 coupled to ISA bus 740. Alternatively, many I/O devices can be accommodated by a super I/O controller (not shown) attached to ISA bus 740.

In order to attach computer system 701 to another computer system to copy files over a network, LAN card 730 is coupled to PCI bus 710. Similarly, to connect computer system 701 to an ISP to connect to the Internet using a telephone line connection, modem 775 is connected to serial port 764 and PCI-to-ISA Bridge 735.

While FIG. 7 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method of installing an operating system on a plurality of computer systems interconnected with a computer network, the method comprising:
identifying, at a first computer system selected from the plurality of computer systems, a plurality of second computer system identifiers corresponding to a plurality of second computer systems also included in the plurality of computer systems;
sending, via the computer network, a Wake-on-LAN instruction from the first computer system to each of the second computer systems using the second computer system identifiers;
booting, over the computer network, the second computer systems from the first computer system;
identifying, at a plurality of selected second computer systems, a plurality of third computer identifiers that corresponds to each of the selected second computer systems;
sending, via the computer network, the Wake-on-LAN instruction from the selected second computer systems to each of the third computer systems using the third computer system identifiers; and
booting, over the computer network, the third computer systems from the selected second computer systems.

2. The method of claim 1, wherein the booting of the second computer systems further comprises:
receiving, at the first computer system, a boot request over the computer network from a plurality of requesters, the boot request including a requester identifier; and
comparing the received requestor identifier to the plurality of second computer system identifiers, wherein the booting is performed in response to the requester identifier matching one of the second computer system identifiers.

3. The method of claim 1 further comprising:
transferring, via the computer network, a control file from the first computer system to the booted second computer systems, wherein the control file lists the plurality of third computer system identifiers corresponding to each of the second computer identifiers; and wherein the identifying of the plurality of third computer system identifiers further includes:
at each of the second computer systems:
reading the control file; and
selecting the plurality of third computer system identifiers that correspond to the identifier of the second computer system.

4. The method of claim 3 further comprising:
at each of the second computer systems receiving boot requests being transmitted over the computer network from a plurality of requesters, wherein each of the boot requests includes a request identifier; and
comparing the received requestor identifiers to the plurality of third computer system identifiers included in the control file, wherein the booting is performed in response one of the requester identifiers matching one of the third computer system identifiers and in response to the third computer system identifier corresponding to the second computer system identifier in the control file.

5. The method of claim 1 further comprising:
transferring an operating system image from the first computer system to each of the booted second computer systems, the operating system image corresponding to an operating system; and
installing the operating system onto each of the second computer systems using the transferred operating system images.

6. The method of claim 1 further comprising:
before sending the Wake-on-LAN instructions to the second computer systems, readying the second and third computer systems, the readying including:
at each of the plurality of computer systems, wherein each of the computer systems including a unique identifier:
receiving a ready instruction at the computer system;
reading a control file that identifies a plurality of server computer identifiers and a plurality of client computer identifiers;
comparing the server computer identifiers with the computer system's unique identifier;
sending the ready instruction to one or more client computer systems corresponding to one or more of the plurality of client computer identifiers in response to the computer system's unique identifier matching one of the server computer identifiers;
setting a Wake-on-LAN flag in the computer system;
setting a boot from LAN flag in the computer system; and
shutting down the computer system.

7. The method of claim 1 further comprising:
the identifying of the plurality of second computer system identifiers including reading a control file at the first computer system, wherein the control file lists the plurality of second computer system identifiers corresponding to the first computer identifier and further lists the plurality of third computer system identifiers corresponding to each of the second computer identifiers;
transferring the control file from the first computer system to each of the second computer systems; and
transferring the control file from the second computer systems to each of the third computer systems.

8. A information handling system comprising:
one or more processors;
a memory accessible by at least one of the processors;
a nonvolatile storage area accessible by at least one of the processors;
a network interface adapter connecting the information handling system to a computer network; and
a set of instructions stored in the memory, wherein one or more of the processors executes the set of instructions for installing an operating system on a plurality of information handling systems interconnected with the computer network, the executed instructions performing actions of:
identifying a plurality of second information handling system identifiers corresponding to a plurality of second information handling systems also included in the plurality of information handling systems;
sending, via the computer network, a Wake-on-LAN instruction from the first information handling system to each of the second information handling systems using the second information handling system identifiers;
booting, over the computer network, the second information handling systems from the first information handling system;
identifying, at a plurality of selected second information handling systems, a plurality of third computer identifiers that corresponds to each of the selected second information handling systems;
sending, via the computer network, the Wake-on-LAN instruction from the selected second information handling systems to each of the third information handling systems using the third information handling system identifiers; and
booting, over the computer network, the third information handling systems from the selected second information handling systems.

9. The information handling system of claim 8, wherein the booting of the second information handling systems further includes instructions that perform further actions comprising:
receiving, at the first information handling system, a boot request over the computer network from a plurality of requesters, the boot request including a requestor identifier; and
comparing the received requestor identifier to the plurality of second information handling system identifiers, wherein the booting is performed in response to the requestor identifier matching one of the second information handling system identifiers.

10. The information handling system of claim 8 wherein the set of instructions perform further actions comprising:
transferring, via the computer network, a control file from the first information handling system to the booted second information handling systems, wherein the control file lists the plurality of third information handling system identifiers corresponding to each of the second computer identifiers; and wherein the identifying of the plurality of third information handling system identifiers further includes:
at each of the second information handling systems:
reading the control file; and
selecting the plurality of third information handling system identifiers that correspond to the identifier of the second information handling system.

11. The information handling system of claim 10 wherein the set of instructions perform further actions comprising:
at each of the second information handling systems receiving boot requests being transmitted over the computer network from a plurality of requesters, wherein each of the boot requests includes a request identifier; and
comparing the received requestor identifiers to the plurality of third information handling system identifiers included in the control file, wherein the booting is performed in response one of the requestor identifiers matching one of the third information handling system identifiers and in response to the third information handling system identifier corresponding to the second information handling system identifier in the control file.

12. The information handling system of claim 8 wherein the set of instructions perform further actions comprising:
transferring an operating system image from the first information handling system to each of the booted second information handling systems, the operating system image corresponding to an operating system; and
installing the operating system onto each of the second information handling systems using the transferred operating system images.

13. The information handling system of claim 8 wherein the set of instructions perform further actions comprising:
before sending the Wake-on-LAN instructions to the second information handling systems, readying the second and third information handling systems, the readying including:
at each of the plurality of information handling systems, wherein each of the information handling systems including a unique identifier:
receiving a ready instruction at the information handling system;
reading a control file that identifies a plurality of server computer identifiers and a plurality of client computer identifiers;
comparing the server computer identifiers with the information handling system's unique identifier;
sending the ready instruction to one or more client information handling systems corresponding to one or more of the plurality of client computer identifiers in response to the information handling system's unique identifier matching one of the server computer identifiers;
setting a Wake-on-LAN flag in the information handling system;
setting a boot from LAN flag in the information handling system; and
shutting down the information handling system.

14. The information handling system of claim 8 wherein the set of instructions perform further actions comprising:
the identifying of the plurality of second information handling system identifiers including reading a control file at the first information handling system, wherein the control file lists the plurality of second information handling system identifiers corresponding to the first computer identifier and further lists the plurality of third information handling system identifiers corresponding to each of the second computer identifiers;
transferring the control file from the first information handling system to each of the second information handling systems; and
transferring the control file from the second information handling systems to each of the third information handling systems.

15. A computer program product stored in a computer readable medium, comprising functional descriptive material that, when executed by a data processing system, causes the data processing system to perform actions of installing an operating system on a plurality of computer systems interconnected with a computer network, the actions including:
identifying, at a first computer system selected from the plurality of computer systems, a plurality of second computer system identifiers corresponding to a plurality of second computer systems also included in the plurality of computer systems;
sending, via the computer network, a Wake-on-LAN instruction from the first computer system to each of the second computer systems using the second computer system identifiers;
booting, over the computer network, the second computer systems from the first computer system;
identifying, at a plurality of selected second computer systems, a plurality of third computer identifiers that corresponds to each of the selected second computer systems;
sending, via the computer network, the Wake-on-LAN instruction from the selected second computer systems to each of the third computer systems using the third computer system identifiers; and
booting, over the computer network, the third computer systems from the selected second computer systems.

16. The computer program product of claim 15, wherein the booting of the second computer systems further includes actions comprising:
receiving, at the first computer system, a boot request over the computer network from a plurality of requesters, the boot request including a requestor identifier; and
comparing the received requestor identifier to the plurality of second computer system identifiers, wherein the booting is performed in response to the requester identifier matching one of the second computer system identifiers.

17. The computer program product of claim 15 wherein the functional descriptive material causes the data processing system to perform further actions comprising:
transferring, via the computer network, a control file from the first computer system to the booted second computer systems, wherein the control file lists the plurality of third computer system identifiers corresponding to each of the second computer identifiers; and wherein the identifying of the plurality of third computer system identifiers further includes:
at each of the second computer systems:
reading the control file; and
selecting the plurality of third computer system identifiers that correspond to the identifier of the second computer system.

18. The computer program product of claim 17 wherein the functional descriptive material causes the data processing system to perform further actions comprising:
at each of the second computer systems, receiving boot requests being transmitted over the computer network from a plurality of requesters, wherein each of the boot requests includes a request identifier; and
comparing the received requestor identifiers to the plurality of third computer system identifiers included in the control file, wherein the booting is performed in response one of the requester identifiers matching one of the third computer system identifiers and in response to the third computer system identifier corresponding to the second computer system identifier in the control file.

19. The computer program product of claim 15 wherein the functional descriptive material causes the data processing system to perform further actions comprising:
before sending the Wake-on-LAN instructions to the second computer systems, readying the second and third computer systems, the readying including:
at each of the plurality of computer systems, wherein each of the computer systems including a unique identifier:
receiving a ready instruction at the computer system;
reading a control file that identifies a plurality of server computer identifiers and a plurality of client computer identifiers;
comparing the server computer identifiers with the computer system's unique identifier;
sending the ready instruction to one or more client computer systems corresponding to one or more of the plurality of client computer identifiers in response to the computer system's unique identifier matching one of the server computer identifiers;
setting a Wake-on-LAN flag in the computer system;
setting a boot from LAN flag in the computer system; and
shutting down the computer system.

20. The computer program product of claim 15 wherein the functional descriptive material causes the data processing system to perform further actions comprising:
the identifying of the plurality of second computer system identifiers including reading a control file at the first computer system, wherein the control file lists the plurality of second computer system identifiers corresponding to the first computer identifier and further lists the plurality of third computer system identifiers corresponding to each of the second computer identifiers;
transferring the control file from the first computer system to each of the second computer systems;
transferring the control file from the second computer systems to each of the third computer systems;
transferring an operating system image from the first computer system to each of the booted second computer systems, the operating system image corresponding to an operating system; and
installing the operating system onto each of the second computer systems using the transferred operating system images.
